(19) United States
(12) Patent Application Publication
(10) Pub. No.: US 2020/0171771 A1
(43) Pub. Date: Jun. 4, 2020

(54) THREAD, WOVEN FABRIC AND METHOD FOR PRODUCING THE SAME

(71) Applicant: HUECK Rheinische GmbH, Viersen (DE)

(72) Inventor: Rolf Espe, Bochum (DE)

(21) Appl. No.: 16/717,054

(22) Filed: Dec. 17, 2019

Related U.S. Application Data
(63) Continuation of application No. PCT/EP2018/068619, filed on Jul. 10, 2018.

(30) Foreign Application Priority Data
Jul. 11, 2017 (DE) DE202017003632.0

(51) Int. Cl. B30B 15/06; D06M 11/09; D01F 11/08; D02G 3/32; D02G 3/40; D02G 3/36; B32B 37/00; B32B 37/10

(52) U.S. Cl. CPC B30B 15/061; D06M 11/09; D01F 11/08; D02G 3/32; D06M 2101/30; D02G 3/36; B32B 37/0046; B32B 37/10; D02G 3/404

(57) ABSTRACT

A thread made from extruded silicone rubber that is crosslinked after extrusion, wherein the thread includes a fluor rubber portion exclusively at a surface of the thread.

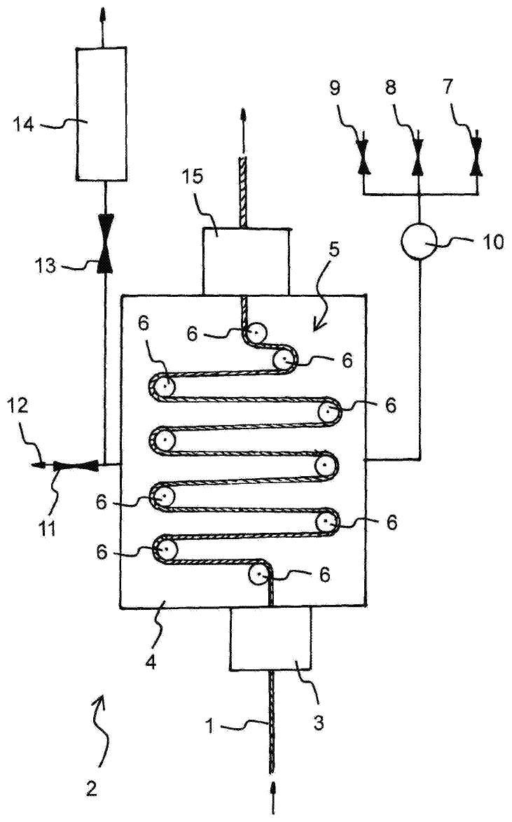

### RELATED APPLICATIONS

This application is a continuation of International application PCT/EP2018/068619 filed on Jul. 10, 2018, claiming priority from German patent application DE 20 2017 003 632.0 filed on Jul. 11, 2017, both of which are incorporated in their entirety by this reference.

### FIELD OF THE INVENTION

The invention relates to a thread made from extruded silicone rubber that is cross-linked after the extrusion and to a woven fabric including warp threads and/or weft threads and a coating made from cross-linked silicone rubber, wherein the thread or the coating include fluorinated rubber. The invention also relates to a method for producing threads and woven fabrics of the type recited supra.

### BACKGROUND OF THE INVENTION

Threads and fabrics of this general type are used in pressure balancing fabrics, so-called press pads, in hydraulic single-layer or multi-layer heated presses when coating wood material plates with decorative papers that are infused with duraplastic resin or when producing high pressure laminates.

Press pads are subjected to high permanent temperatures in the heating presses. Additionally there are chemical impacts from oil that leaks from the equipment. Another chemical impact is the steam impact, e.g., from formaldehyde, which escapes from the plate and resin materials. This leads to a premature wear of the pads so that the reset properties are greatly reduced. Since vulcanized silicone rubbers and their copolymers tend to develop sticky surfaces, the threads have to be treated with talcum powder, silicone oils or other additives after extrusion so that they do not stick together during windup and so that no running problems occur during a subsequent weaving process. Fluor rubber (FKM) and fluor silicone rubber (MFQ/FVMQ) have better thermal and chemical resistance compared to silicone rubber (MVQ/VMQ).

DE 200 08249U1 discloses a press pad with the thread described supra and proposes to fabricate the thread from a blended elastomeric material by producing a mix from a conventional silicone rubber and a silicone fluor rubber before crosslinking. The fluor rubber portion on the surface of the thread is too small to provide sufficient protection against the chemicals recited supra.

EP 1 300 235 A1 proposes to coat a fabric made from metal heat conducting threads with a silicone rubber in order to produce a press pad and to cross-link the coating thereafter. DE 23 19 593 A1 discloses an additional press pad with a metal fabric embedded in a silicone elastomeric material. EP 0 735 949 A1 discloses a press pad with a fabric made from silicone elastomeric threads and metal threads.

### BRIEF SUMMARY OF THE INVENTION

It is an object of the invention to improve thermal and chemical resistance.

Improving upon known threads, it is proposed according to the invention that the thread includes the fluor rubber portion only at a surface. Concentrating the fluor rubber portion at the surface of the thread significantly improves thermal and chemical resistance of the surface.

According to the invention, a fabric advantageously includes threads of this type as warp threads and/or weft threads. A fabric with threads from silicone elastomeric material is known in the art.

Improving upon the known fabric, it is proposed as an alternative according to the invention that the coating only includes the fluor rubber portion at a surface. Also here the concentration of the fluor rubber portion at the surface of the coating significantly improves thermal and chemical resistance of the coating.

Advantageously the warp and/or weft threads of a fabric according to the invention are made from metal. The warp and/or weft threads have significantly increased mechanical stability. Further advantageously the metal is stranded. The warp threads and/or web threads then have a higher tensile strength and higher bending elasticity than a solid wire with identical cross section. Further advantageously the metal is copper. The warp and/or weft threads then have higher heat conductivity compared to other metals.

Advantageously a hydraulic press is operated according to the invention with a press pad made from this fabric. Press pads and operating hydraulic presses with fabrics made from or with silicone elastomeric material are known in the art.

Improving upon the known method for fabricating a thread or a coated fabric it is proposed according to the invention that the fluor rubber portion is only produced by surface fluor treatment of the cross linked thread or coating with a fluor treatment gas. The method according to the invention produces one of the threads or fabrics described supra and is also characterized by the advantages recited supra.

Advantageously the warp and/or weft threads are initially coated with the silicone rubber in a method according to the invention and subsequently woven to form the fabric. This sequence is known e.g. from DE 200 082 49 U1

Further advantageously the silicone rubber is cross linked and fluorinated before weaving in a method according to the invention. Also cross linking before weaving is known e.g. from DE 200 082 49 U1. Fluorination reduces surface tension of the silicone elastomeric material, thus of the silicone rubber after cross linking. This substantially improves running properties of the thread in the weaving machine. The fabric, thus provides reduced abrasion at the elastomeric threads during operations.

Alternatively the warp and/or weft threads are initially woven into the fabric according to the method according to the invention and the fabric is coated with the silicone rubber. This sequence is known e.g. from EP 1 300 235 A1.

Advantageously the fluor treatment gas is made from at least 0.5 volume percent from fluor gas or from a fluor treatment agent and by at least 50 volume percent from an inert gas. Further advantageously the fluor treatment gas is made from 10 volume percent fluor gas or fluor treatment agent.

### BRIEF DESCRIPTION OF THE DRAWINGS

The invention is now described based on an embodiment with reference to a drawing FIGURE.

### DETAILED DESCRIPTION OF THE INVENTION

A thread 1 according to the invention is continuously extruded with 1.5 mm thickness from a non-crosslinked silicone rubber with a core thread made from stranded copper threads and crosslinked into a silicone elastomeric material in a heating zone that is downstream of the extruder. The drawing FIGURE illustrates an arrangement 2 for further processing a thread 1 after extrusion and crosslinking. The thread 1 runs through a first gate system 3 into a processing chamber 4. A roller system 5 with rising rollers and descending rollers 6 determines a processing time of the fluorization gas in the range of approximately two minutes based on a number of the rollers 6 and their distances.

The arrangement 2 is supplied with gas through a valve 7 that introduces inert gas, a valve 8 that introduces a fluor gas mix and a valve 9 that introduces air. A dosing measuring device 10 measures the introduced gas volumes. Another valve 8 controls the exhaust conduit 12, and a last valve 13 controls the exhaust gas to the absorber 14 for precipitating hydrogen fluoride and hydrogen fluoride mixes.

The fluoride thread 1 exits the arrangement 2 through a second gate system 15 and is then run to the winding station which is not illustrated. The gate systems 3, 15 prevent an exit of a non-illustrated fluorization gas from the processing chamber 4.

After exiting from the heating zone, the thread 1 has a temperature between 50 and 80 degrees C., which helps fluorization. In an alternative embodiment, the processing chamber 4 can be fitted with an additional heater.

The processing chamber 4 is initially flushed with inert gas (nitrogen argon neon, helium or another noble gas) at atmospheric pressure at room temperature and purged from air, thereafter the fluorization gas including 10 volume % fluor gas (F₂) and 90 volume % nitrogen (N₂) is introduced. In an alternative embodiment, the fluorization gas can be made from halogen or noble gas fluoride instead of molecular fluoride.

A dosing device 10 controls filling of the processing chamber 4 while the valve to the absorber is closed. Since the process is continuous, the process gas has to be continuously regulated.

The fluorization is a chemical reaction and not a coating. Therefore, a penetration depth of the fluoride atoms into the surface of the silicone elastomeric material is in the molecular range. The thread and the coating, therefore, have a fluorosilicone portion only in their surface. The main chain of silicone rubber is made from alternating silicone and oxygen atoms and attached hydrocarbon groups. The fluorization replaces hydrogen atoms with fluor atoms at a surface in the hydrocarbon groups. The hydrogen fluoride (HF) that is being generated is run over a calcium carbonate absorber and converted into calcium fluoride.

After fluorization the elastomeric threads are made from polymethylsiloxane and fluorosilicone rubber copolymers. Since a binding energy of carbon and fluor is higher than a binding energy of carbon and hydrogen, the fluorosilicone rubber that is being produced has much higher thermal and chemical resistance.

The high elasticity of the silicone elastomeric material is maintained. The fluorized surfaces furthermore have a blocking layer against non-polarized substances. Simultaneously, a permeation, diffusion and migration and an exit of volatile components from the silicone elastomeric material which can lead to odors is reduced. Overall, an extended service life of the press pads with constant material quality is achieved.

The coating of the thread 1 has a surface tension of 31 mN/m before fluorization and a surface tension 56 mN/m after fluorization. The static friction and dynamic friction is reduced by half from approximately 4.5 Newton to 2 Newton. The friction forces on glass are reduced from approximately 10 Newton to 0.8 Newton. The surface of the thread 1 according to the invention therefore does not have any tackiness after fluorization. Using release agent additives, in particular talcum powder, before the threads 1 are wound onto the coils is not required. Contaminations by deposits of the release additives at the machine components of the weaving arrangements do not occur anymore. The thread 1 runs perfectly without stopping, in particular in the weft direction, in the weaving plant. The static friction and the dynamic friction and tackiness is significantly reduced compared to the prior art or eliminated. Additionally, anaerobic aging is substantially prevented by depolymerization of the silicone elastomeric material.

The thread 1 according to the invention and the press pad made from the thread according to the invention have a high level of resistance against hot vapor, hot naphtha oil and aromatic oils, gasoline, olefatic and aromatic olefins, ketones, silicone oil, hydrogen fluorides, acids and bases, and good long-term resistance and good long-term stability at high temperatures greater than 130 degrees C. The thread 1 and the press pad have a high level of flexibility and good resetting properties.

### REFERENCE NUMERALS AND DESIGNATIONS

1. Thread
2. Arrangement
3. Gate system
4. Treatment chamber
5. Roller system
6. Roller
7. Valve for inert gas
8. Valve for fluor gas and fluor gas mix
9. Valve for air
10. Dosing measuring device
11. Exhaust air valve
12. Exhaust air conduit
13. Exhaust air valve
14. Absorber
15. Gate system

What is claimed is:

1. A thread made from extruded silicone rubber that is crosslinked after extrusion, wherein the thread includes a fluor rubber portion exclusively at a surface of the thread.

2. A fabric, comprising: warp threads or weft threads that are made from the thread according to claim 1.

3. The fabric according to claim 2, wherein the warp threads or weft threads are made from a stranded metal or stranded copper.

4. A hydraulic press, comprising a press pad made from the fabric according to claim 2.

5. A method for producing a thread, the method comprising the steps:
continuously extruding the thread from silicone rubber;
crosslinking the thread after the extruding; and
producing fluor rubber in the thread exclusively by fluorizing a surface of the thread after the crosslinking,
wherein the fluorizing is performed by a fluorizing gas.

6. A method for producing a fabric, the method comprising the steps:
providing warp threads or weft threads with a coating made from silicone rubber;
crosslinking the silicone rubber; and
performing surface fluorization of the coating with a fluorization gas to produce fluor rubber in the coating.

7. The method for producing the fabric according to claim 6, wherein the warp threads or weft threads are initially coated by the silicone rubber and subsequently woven into the fabric.

8. The method according to claim 6, wherein the silicone rubber is crosslinked and fluorized before weaving.

9. The method according to claim 6, wherein the warp threads or weft threads are initially woven into the fabric and the fabric is coated with the silicon rubber thereafter.

10. The method according to one of the claim 5, wherein the fluorization gas is made from at least 0.5% by volume or at least 10% by volume fluoride gas or fluorization agent and from at least 50% volume % inert gas.

11. A hydraulic press, comprising a press pad made from the fabric according to claim 3.

12. The method according to claim 7, wherein the silicone rubber is crosslinked and fluorized before weaving.
